(19) United States
(12) Patent Application Publication
(10) Pub. No.: US 2024/0338168 A1
(43) Pub. Date: Oct. 10, 2024

(54) METHOD OF RENDERING LYRICS OF A SOUND RECORDING MORE EASILY UNDERSTOOD BY A LISTENER

(71) Applicant: David W. Ostrander, Holyoke, MA (US)

(72) Inventor: David W. Ostrander, Holyoke, MA (US)

(21) Appl. No.: 18/602,441

(22) Filed: Mar. 12, 2024

Related U.S. Application Data
(60) Provisional application No. 63/457,266, filed on Apr. 5, 2023.

(51) Int. Cl. G06F 3/16

(52) U.S. Cl. CPC G06F 3/165

(57) ABSTRACT

A method of rendering lyrics of a sound recording more easily understood by a listener, is provided. Also provided by way of the present invention is a computer-implemented method of adding spoken (not sung) lyrics to a pre-existing sound recording of one or more people singing a song to improve a listener's ability to understand the lyrics, as well as a sound recording having spoken (not sung) lyrics overlaid and/or inserted into the recording.

### CROSS-REFERENCE TO RELATED APPLICATION

This application claims the benefit of priority of U.S. Provisional Patent Application Ser. No. 63/457,266, filed on Apr. 5, 2023, the contents of which are herein incorporated by reference.

### TECHNICAL FIELD

The present invention generally relates to a method of rendering lyrics of a sound recording more easily understood by a listener, to a computer-implemented method of adding spoken, not sung, lyrics to a pre-existing sound recording, and to a sound recording of one or more people singing a song, which has spoken (not sung) lyrics overlaid and/or inserted into the recording.

### BACKGROUND OF THE INVENTION

There are several reasons why listeners find it much more difficult to understand song lyrics than spoken words. A lot of singers do not enunciate properly. The delivery may be so rapid that it's very difficult to understand and oftentimes the “mix” of the instruments overpower the vocals. For those listeners intrigued by a song and its lyrics, but unable to fully understand the song lyrics, the internet may provide them with the written lyrics. Not understanding a song's lyrics and having to look up the written lyrics to gain an understanding of the song, however, detracts from the song's immediate enjoyment. Further, a listener may not always be able to access the written lyrics online or otherwise after listening to a song, like when the listener is driving a car.

The present invention addresses this problem by targeting pre-existing songs with at least partially incomprehensible lyrics, and by customizing such pre-existing songs by complementing the at least partially incomprehensible sung lyrics with spoken lyrics to improve the understandability of the musical work.

U.S. Patent Application Publication No. 2006/0028951 A1 to Tozun et al. relates to a method for creating a customized audio track that involves the steps of creating a song template, and then defining insert regions where sounds, vocals, or the like are inserted into the template. The customized audio track may comprise a personalized song (using appropriate name inserts) or a cell phone ring tone that identifies the caller.

U.S. Pat. No. 9,721,551 to Silverstein relates to an automated music composition and generation machine, systems and methods, and architectures that purportedly allow anyone, without possessing any knowledge of music theory or practice, or expertise in music or other creative endeavors, to instantly produce unique and professional-quality music, synchronized to any kind of media content, as well as any object, entity, and/or event.

None of these references, however, identify the problem of pre-existing songs having incomprehensible lyrics and therefore does not teach or suggest a solution to this problem. It is an object of the present invention to provide such a solution.

### SUMMARY OF THE INVENTION

The present invention therefore provides a method of rendering lyrics of a sound recording more easily understood by a listener, the method comprising: modifying a pre-existing sound recording of one or more people singing a song by overlying and/or inserting spoken (not sung) lyrics into existing or inputted gaps or pauses in the recording.

The present invention further provides a computer-implemented method of adding spoken (not sung) lyrics into a pre-existing sound recording of one or more people singing a song to improve a listener's ability to understand the lyrics, which comprises: identifying the location within the pre-existing sound recording of one or more portions of sung lyrics, which are deemed by a listener as being imperceptible or difficult to understand; marking the beginning and end points of each portion of the imperceptible sung lyrics within the pre-existing sound recording, wherein the end point of each portion of imperceptible sung lyrics will be an insert point for a clarifying audio file of spoken (not sung) lyrics; preparing or importing one or more clarifying audio files of spoken (not sung) lyrics to supplement the one or more portions of the imperceptible sung lyrics; optionally, modifying the existing sound recording by forming one or more modification fields either beginning at the insert point for select portions of lyrics deemed imperceptible or difficult to understand, or positioned adjacent to an existing gap or pause following a portion of imperceptible sung lyrics in the sound recording, and then modifying the pre-existing sound recording by at least one of:
overlying an audio file onto each existing gap or pause following a portion of imperceptible sung lyrics in the sound recording;
inserting an audio file into each modification field inputted following a portion of imperceptible sung lyrics in the sound recording;
overlying a portion of an audio file onto an existing gap or pause following a portion of imperceptible sung lyrics in the sound recording and inserting a remaining portion of the audio file into a modification field inputted following the existing gap or pause in the recording; and
inserting a portion of an audio file into a modification field inputted following a portion of imperceptible sung lyrics in the sound recording but before an existing gap or pause in the sound recording, and overlying a remaining portion of the audio file onto the existing gap or pause following the modification field,
   to clarify the sung lyrics.

Also provided is a modified sound recording of one or more people singing a song, wherein the sound recording has been modified to include spoken (not sung) lyrics overlaid on top of in existing gaps or pauses in the recording, and/or inserted into inputted gaps or pauses in the recording.

### BRIEF DESCRIPTION OF THE DRAWINGS

The present disclosure may be better understood with reference to the following drawings. Matching reference numerals designate corresponding parts throughout the drawings, and components in the drawings are not necessarily to scale, emphasis instead being placed upon clearly illustrating the principles of the present disclosure.

While exemplary embodiments are disclosed in connection with the drawings, there is no intent to limit the present disclosure to the embodiment or embodiments disclosed herein. On the contrary, the intent is to cover all alternatives, modifications, and equivalents.

Particular features of the disclosed invention are illustrated by reference to the accompanying drawings in which:

FIGS. 1, 2, 3, 4 and 5 are a series of schematic depictions of computer screen windows showing an exemplary embodiment of the steps involved in inserting spoken (not sung) lyrics into a pre-existing sound recording to improve a listener's ability to understand the lyrics.

### DETAILED DESCRIPTION OF THE INVENTION

The inventive method of rendering lyrics of a sound recording more easily understood by a listener, which comprises modifying a pre-existing sound recording of one or more people singing a song by overlying and/or inserting spoken (not sung) lyrics onto/into existing or inputted gaps or pauses in the recording, may be implemented using software applications allowing for the digital modification of digital audio and music files. One such software application is Audacity® downloadable computer software, which is a free and open-source digital audio editor for producing, recording, editing, analyzing, and mixing digital audio and music.

In an exemplary embodiment, the inventive method is a computer-implemented method. The method comprises customizing pre-existing sound recordings having lyrics sung by music artists, where the sung lyrics are at least partially incomprehensible (e.g., voice fuzzy, buried). The pre-existing sound recording is converted to, for example, a digital music file, and those portions of the pre-existing sound recording having at least partially incomprehensive sung lyrics are marked. If adequately sized gaps or pauses are not already present in the recording after each marked portion of the recording having incomprehensive sung lyrics, then the recording is provided with modification fields. An audio file of the spoken (not sung) lyrics corresponding to the sung lyrics immediately preceding the gap or pause, or modification field, is overlaid onto the pre-existing gap or pause and/or inputted into the modification field.

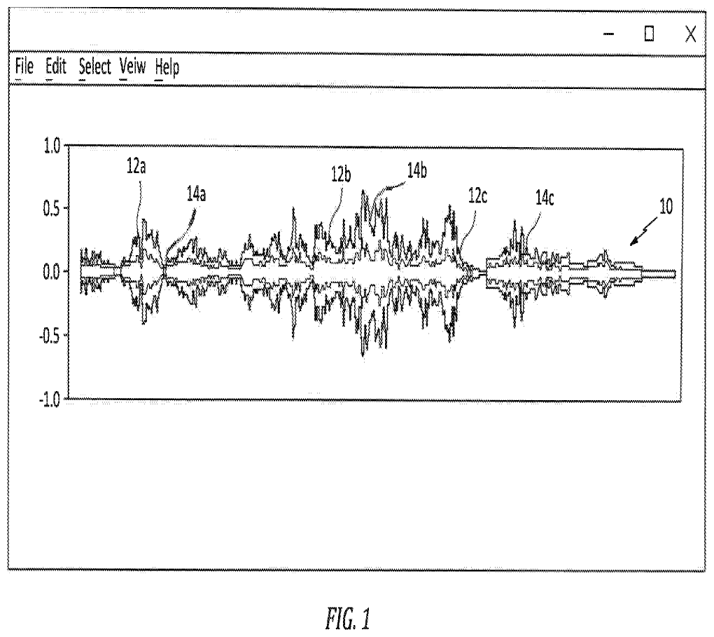

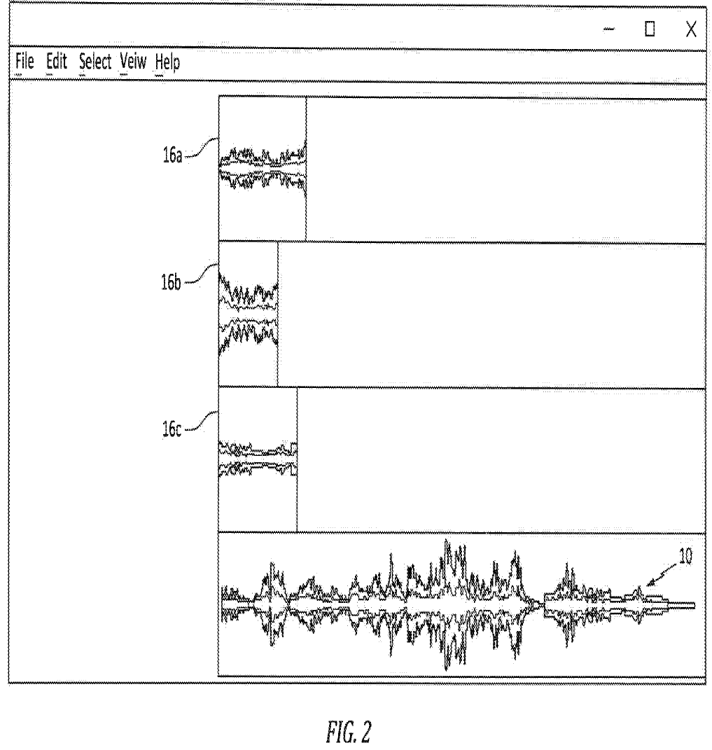

One such embodiment of the inventive computer-implemented method is shown in FIGS. 1-5, where a pre-existing sound recording of one or more people singing a song is modified using digital audio editing software. Referring now to FIG. 1, the pre-existing sound recording, which is marked by reference number 10, is imported into the software program as a digital music file and examined methodically and in detail to identify the location(s) of the sung lyrics which are deemed by a listener as imperceptible (e.g., words which are: (i) not enunciated properly; (ii) delivered too rapidly; and/or (iii) overpowered by the “mix” of the instruments). The imperceptible sung lyrics are marked with respect to the point in time in which the lyrics are first present in the song 12a, 12b, 12c, and the duration thereof (the “end point”) 14a, 14b, 14c, the “end point” becoming the “insert point” of the spoken (not sung) lyrics that serve to clarify the words for a listener. As shown in FIG. 2, once the timing and location of each portion of the sung lyrics, which are deemed at least partially imperceptible, are determined, audio tracks or clips in the form of spoken lyrics 16a, 16b, 16c, may be generated and then imported into the program, or audio media may be a recording captured by the program (e.g., Audacity's Audio Recorder). The audio clips of the spoken lyrics may be generated or imported with or without background music. If generated or imported with background music, the background music may match the background music used in the portion of sung lyrics that is being clarified.

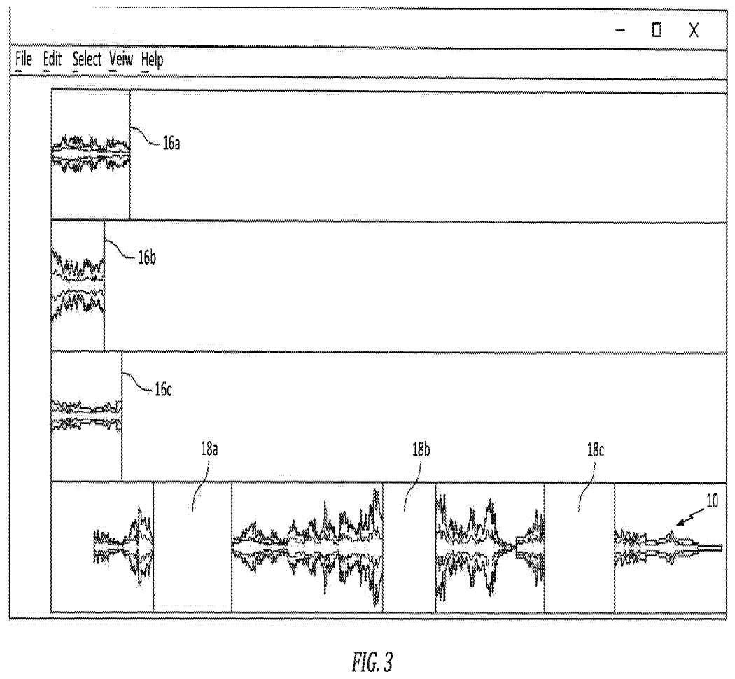

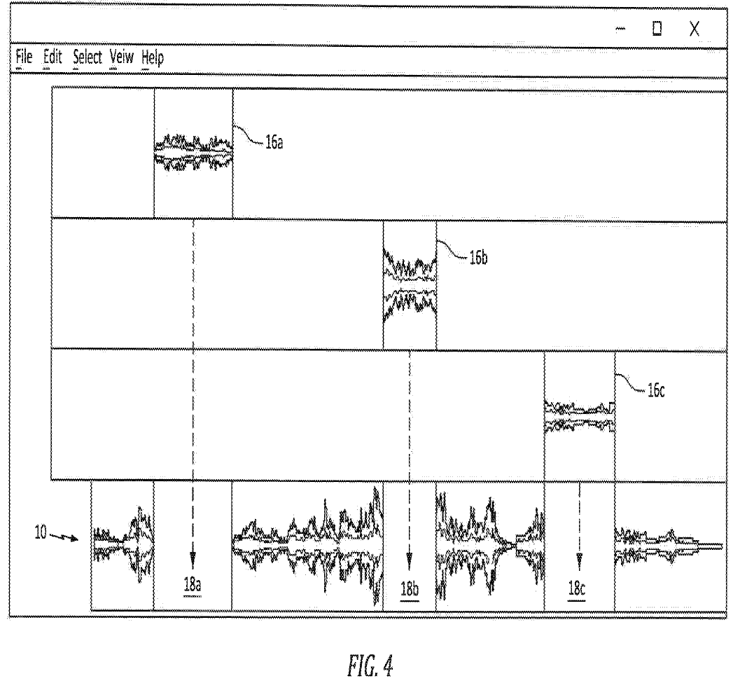

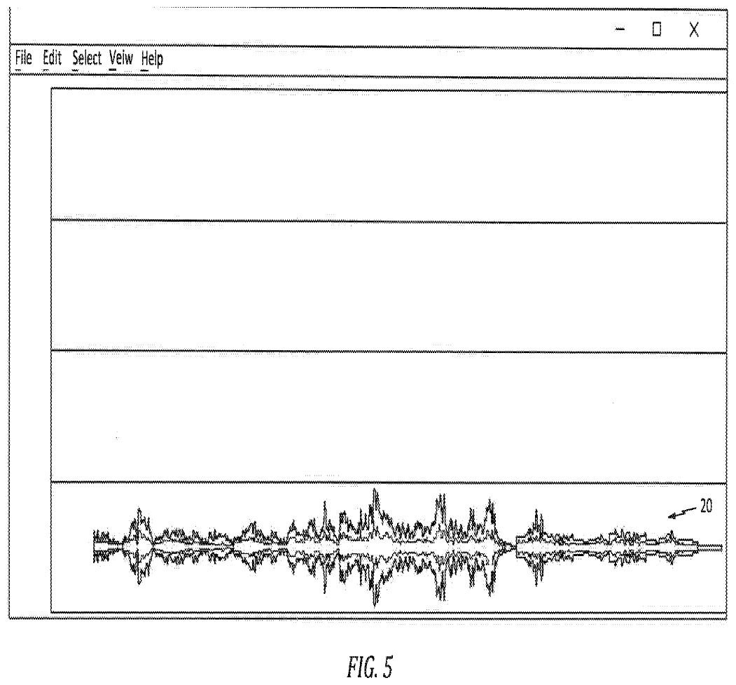

Referring now to FIG. 3, modification fields 18a, 18b, 18c, in the pre-existing sound recording 10 may be produced either before and after the audio clips 16a, 16b, 16c, are generated or imported. Modification fields are produced by clipping the insert points of the sound recording, and then spatially separating the adjacent portions of the sound recording by clicking and dragging the right-hand portion away from the left-hand portion in an amount sufficient to accommodate the respective audio file. As shown in FIG. 4, once the modification fields 18a, 18b, 18c, are generated, the audio files 16a, 16b, 16c, are transversely moved along their respective track by clicking and dragging the audio file to position it over the intended modification field, and then the audio file is inserted into its respective modification field by clicking and dragging the audio file into the modification field, so that, as shown in FIG. 5, the modified sound recording 20 with inserted spoken lyric audio files are on one track.

As noted above, a modification field may not be necessary if an adequately sized gap or pause is already present in the pre-existing sound recording after a portion marked with incomprehensible lyrics. The term “adequately sized”, as used herein, means that the overall size (e.g., length or duration) of the gap or pause substantially matches the overall size of the preceding portion of the sound recording having at least partially incomprehensible sung lyrics. If an adequately sized gap or pause is already present in the recording, then the gap or pause may be overlaid with the respective audio file. For existing gaps or pauses which are not adequately sized, a modification field may be used in combination with the gap or pause. In one such embodiment, a portion of the audio file is overlaid on top of the gap or pause, while a remaining portion of the audio file is inserted into the modification field, which is positioned adjacent to the gap or pause.

Editing tools in the digital audio editing software will also allow for manipulating audio to assure a high-quality by, for example, eliminating silent areas in each overlaid or inserted audio file, by adjusting the volume of a specific section of an audio track to match adjoining sections, etc. Once the final edits have been performed on the modified sound recording 20, it may be recorded and/or streamed.

The modified sound recording 20 of the present invention clarifies incomprehensible lyrics with spoken lyrics, thereby improving the musical work's understandability and assuring the song's immediate enjoyment by a listener.

Although exemplary embodiments have been shown and described, it will be clear to those of ordinary skill in the art that a number of changes, modifications, or alterations to the invention as described can be made. All such changes, modifications, and alternations should therefore be seen as within the scope of the disclosure.

We claim:

1. A method of rendering lyrics of a sound recording more easily understood by a listener, the method comprising: modifying a pre-existing sound recording of one or more people singing a song by at least one of: (i) overlying spoken, not sung, lyrics onto existing gaps or pauses in the recording; (ii) inserting spoken, not sung, lyrics into inputted gaps or pauses in the recording; and (iii) overlying a portion of spoken, not sung, lyrics onto an existing gap or pause in the recording and inserting a remaining portion of the spoken, not sung, lyrics into an inputted gap or pause in the recording, the inputted gap or pause being positioned adjacent to the existing gap or pause.

2. The method of claim 1, wherein the pre-existing sound recording is modified using a software application for digital modification of digital audio and music files.

3. A computer-implemented method of adding spoken, not sung, lyrics into a pre-existing sound recording of one or more people singing a song to improve a listener's ability to understand the lyrics, which comprises: identifying the location within the pre-existing sound recording of one or more portions of sung lyrics, which are deemed by a listener as being imperceptible or difficult to understand; marking the beginning and end points of each portion of imperceptible sung lyrics within the pre-existing sound recording, wherein the end point of each portion of imperceptible sung lyrics will be an insert point for a clarifying audio file of spoken (not sung) lyrics; preparing or importing one or more clarifying audio files of spoken (not sung) lyrics to supplement each portion of imperceptible sung lyrics; optionally, modifying the existing sound recording by forming one or more modification fields either beginning at the insert point for select portions of lyrics deemed imperceptible or difficult to understand, or positioned adjacent to an existing gap or pause following a portion of imperceptible sung lyrics in the sound recording, and then modifying the pre-existing sound recording by at least one of:
(i) overlying an audio file onto each existing gap or pause following a portion of imperceptible sung lyrics in the sound recording;
(ii) inserting an audio file into each modification field inputted following a portion of imperceptible sung lyrics in the sound recording;
(iii) overlying a portion of an audio file onto an existing gap or pause following a portion of imperceptible sung lyrics in the sound recording and inserting a remaining portion of the audio file into a modification field inputted following the existing gap or pause in the recording; and
(iv) inserting a portion of an audio file into a modification field inputted following a portion of imperceptible sung lyrics in the sound recording but before an existing gap or pause in the sound recording, and overlying a remaining portion of the audio file onto the existing gap or pause following the modification field,
to clarify the sung lyrics.

4. The computer-implemented method of claim 3, wherein the sound recording is converted to a digital music file, and then modified using digital audio editing software.

5. The computer-implemented method of claim 4, wherein the clarifying audio files of spoken (not sung) lyrics are prepared or imported without background music.

6. The computer-implemented method of claim 4, wherein the clarifying audio files of spoken (not sung) lyrics are prepared or imported with background music.

7. The computer-implemented method of claim 6, wherein the background music matches the background music used in the portion of the sung lyrics that is being clarified.

8. The computer-implemented method of claim 4, wherein modification fields are formed by clipping the insert points of the sound recording, and then spatially separating the adjacent portions of the sound recording by clicking and dragging the right-hand portion away from the left-hand portion in an amount sufficient to accommodate the respective audio file.

9. The computer-implemented method of claim 8, wherein the audio files are transversely moved along their respective track by clicking and dragging the audio file to position it over the intended modification field, and then the audio file is inserted into its respective modification field by clicking and dragging the audio file into the modification field, so that the modified sound recording with inserted spoken lyric audio files are on one track.

10. The computer-implemented method of claim 4, which further comprises using editing tools in the digital audio editing software to eliminate silent areas in each overlaid or inserted audio file and to adjust the volume of a specific section of an audio track to match adjoining sections.

11. A sound recording made in accordance with the computer-implemented method of claim 3.

12. A modified sound recording of one or more people singing a song, which comprises at least one of:
(i) spoken, not sung, lyrics overlaid onto existing gaps or pauses in the recording;
(ii) spoken, not sung, lyrics inserted into inputted gaps or pauses in the recording;
(iii) a portion of spoken, not sung, lyrics overlaid onto an existing gap or pause in the recording and a remaining portion of the spoken, not sung, lyrics inserted into an inputted gap or pause in the recording, the inputted gap or pause being positioned adjacent to the existing gap or pause; and
(iv) a portion of spoken, not sung, lyrics inserted into an inputted gap or pause in the sound recording, which is positioned before an existing gap or pause in the recording, and a remaining portion of the spoken, not sung, lyrics overlaid onto the existing gap or pause positioned adjacent to the inputted gap or pause in the sound recording.
